(19) United States
(12) Patent Application Publication
(10) Pub. No.: US 2015/0032743 A1
(43) Pub. Date: Jan. 29, 2015

(54) ANALYZING FILES USING BIG DATA TOOLS

(71) Applicant: CIMCON Software, Inc., Westford, MA (US)

(72) Inventor: Sanjay Agrawal, Westford, MA (US)

(21) Appl. No.: 14/335,579

(22) Filed: Jul. 18, 2014

Related U.S. Application Data
(60) Provisional application No. 61/847,828, filed on Jul. 18, 2013.

(51) Int. Cl. G06F 17/30; G06F 17/24

(52) U.S. Cl. CPC G06F 17/30115; G06F 17/246; G06F 17/30194
USPC 707/736

(57) ABSTRACT

This document describes technology that can be embodied in a method that includes accessing a file representing at least one spreadsheet, and analyzing the file to identify a plurality of components of the spreadsheet. The plurality of components includes at least two of: (i) a component representing content of the at least one spreadsheet, (ii) a component representing one or more formulae associated with the at least one spreadsheet, (iii) a component representing one or more macros, (iv) a component representing one or more queries, and (v) a component representing links associated with the at least one spreadsheet. The method also includes creating, based on the components of the spreadsheet, a plurality of files that together represents the at least one spreadsheet, and storing the plurality of files at a storage location. Each of the plurality of files corresponds to a particular component.

### CLAIM OF PRIORITY

This application claims priority under 35 USC §119(e) to U.S. Patent Application Ser. No. 61/847,828, filed on Jul. 18, 2013, the entire contents of which are hereby incorporated by reference.

### TECHNICAL FIELD

The present description relates to analysis of computer-readable files.

### BACKGROUND

Big data tools are becoming popular to analyze vast volumes of data. The information technology research and advisory company Gartner defined big data as: “Big data are high volume, high velocity, and/or high variety information assets that require new forms of processing to enable enhanced decision making, insight discovery and process optimization.”

### SUMMARY

In one aspect, this document features a computer-implemented method that includes accessing, by one or more processing devices, a file representing at least one spreadsheet, and analyzing the file by the one or more processing devices to identify a plurality of components of the spreadsheet. The plurality of components includes at least two of: (i) a component representing content of the at least one spreadsheet, (ii) a component representing one or more formulae associated with the at least one spreadsheet, (iii) a component representing one or more macros, (iv) a component representing one or more queries, and (v) a component representing links associated with the at least one spreadsheet. The method also includes creating, based on the components of the spreadsheet, a plurality of files that together represents the at least one spreadsheet, and storing the plurality of files at a storage location. Each of the plurality of files correspond to a particular component of the identified plurality of components.

In another aspect, this document features a computer-implemented method that includes accessing, by one or more processing devices, a file representing at least one drawing, and analyzing the file by the one or more processing devices to identify a plurality of components of the drawing. The plurality of components includes at least two of: (i) a component representing an object and coordinates associated with the object, (ii) a component representing one or more layers, (iii) a component representing one or more colors, (iv) a component representing one or more blocks, and (v) a component representing one or more external references. The method also includes creating, based on the components of the drawing, a plurality of files that together represents the drawing, and storing the plurality of files at a storage location. Each of the plurality of files correspond to a particular component of the identified plurality of components.

In another aspect, this document features a system that includes a storage device configured to store one or more files representing at least one spreadsheet, and a computing device including a memory and processor. The computing device is configured to access the one or more files stored in the storage device, and analyze the file to identify a plurality of components of the spreadsheet. The plurality of components includes at least two of: (i) a component representing content of the at least one spreadsheet, (ii) a component representing one or more formulae associated with the at least one spreadsheet, (iii) a component representing one or more macros, (iv) a component representing one or more queries, and (v) a component representing links associated with the at least one spreadsheet. The system is also configured to create a plurality of files that together represents the at least one spreadsheet, and store the plurality of files at a storage location. Each of the plurality of files correspond to a particular component of the identified plurality of contents.

In another aspect, this document features a system that includes a storage device configured to store one or more files representing at least one drawing file, and a computing device including a memory and processor. The computing device is configured to access the one or more files stored in the storage device, and analyze the file to identify a plurality of components of the drawing. The plurality of components includes at least two of: (i) a component representing an object and coordinates associated with the object, (ii) a component representing one or more layers, (iii) a component representing one or more colors, (iv) a component representing one or more blocks, and (v) a component representing one or more external references. The computing device is also configured to create, based on the components of the drawing, a plurality of files that together represents the drawing, and store the plurality of files at a storage location. Each of the plurality of files correspond to a particular component of the identified plurality of contents.

In another aspect, this document features a computer-readable storage device storing instructions executable by one or more processing devices which, upon execution, cause the one or more processing devices to perform various operation. The operations include accessing a file representing at least one spreadsheet, and analyzing the file to identify a plurality of components of the spreadsheet. The plurality of components includes at least two of: (i) a component representing content of the at least one spreadsheet, (ii) a component representing one or more formulae associated with the at least one spreadsheet, (iii) a component representing one or more macros, (iv) a component representing one or more queries, and (v) a component representing links associated with the at least one spreadsheet. The operations also include creating, based on the components of the spreadsheet, a plurality of files that together represents the at least one spreadsheet, and storing the plurality of files at a storage location. Each of the plurality of files correspond to a particular component of the identified plurality of contents.

In another aspect, this document features a computer-readable storage device storing instructions executable by one or more processing devices which, upon execution, cause the one or more processing devices to perform various operation. The operations include accessing a file representing at least one drawing, and analyzing the file to identify a plurality of components of the drawing. The plurality of components includes at least two of: (i) a component representing an object and coordinates associated with the object, (ii) a component representing one or more layers, (iii) a component representing one or more colors, (iv) a component representing one or more blocks, and (v) a component representing one or more external references. The operations also include creating, based on the components of the drawing, a plurality of files that together represents the drawing, and storing the plurality of files at a storage location. Each of the plurality of files correspond to a particular component of the identified plurality of contents.

Implementations can include one or more of the following features.

The file representing the at least one spreadsheet can be in a binary format. The plurality of files can be in a format that can be processed by an analytics system configured to process large-scale datasets stored across a plurality of storage devices. The volume of the large-scale datasets can be represented in one of: petabytes (10¹⁵ bytes), zettabytes (10²¹ bytes), yottabytes (10²⁴ bytes) or brontobytes (10²⁷ bytes). The analytics system can include a Big Data analytics system. Each of the plurality of files can be in a non-binary format. The plurality of components further includes a component representing event-driven programming language codes associated with the at least one spreadsheet. The event-driven programming language can be Visual Basic for Applications (VBA). Each of the plurality of files can be a text file. The analytics system can include a framework for processing the large-scale dataset. The framework can be an Apache Hadoop framework. The storage location can be a part of a distributed file system associated with the framework. Results based on an analysis of the plurality of files can be received from the analytics system, and the results can be either stored in a storage device or displayed on a display device.

Other aspects, features, and advantages will be apparent from the description and the claims.

### BRIEF DESCRIPTION OF THE DRAWINGS

FIG. 1 is a block diagram of an environment that facilitates analysis of computer-readable files.

FIG. 2 is an example of a system that can be used for implementing the technology described herein.

FIGS. 3A and 3B are examples where big data compatible files are created from spreadsheet and drawing files, respectively.

FIG. 4 is an example of a graphical user interface showing results obtained by analyzing spreadsheets.

FIGS. 5A-5D are examples of files that can be analyzed using big data tools.

FIGS. 6 and 7 are flowcharts for example sequences of operations carried out to analyze spreadsheets and drawings, respectively.

FIG. 8-16 are examples of user interfaces.

FIG. 17 is an example of a computer system.

### DETAILED DESCRIPTION

The need for processing vast volumes of data in modern computing systems and applications has resulted in specialized computing tools that can process such volumes of data. These tools can process petabytes (10¹⁵ bytes), zettabytes (10²¹ bytes), yottabytes (10²⁴ bytes) or brontobytes (10²⁷ bytes) of data, for example to facilitate insight discovery and enable enhanced decision making based on such high volume data. Such high volume data is often referred to using the phrase Big Data (or big data), and the software and/or hardware tools used in analyzing such high volume data is often referred to as big data tools. Big data tools can be used to, for example, capture, curate, store, search, share, transfer, analyze and visualize high volume data, and may allow discovery of correlations that may not be detectable using traditional data analysis systems such as relational database management systems. Instead, processing such high volume data often require massively parallel distributed systems running on tens, hundreds, or even thousands of servers. The big data tools used for processing such high volume data are most effective when processing unstructured files or files with relatively low complexity. Examples of such files include non-binary files such as text files. On the other hand, using the big data tools to process binary files (e.g., spreadsheets, drawings or other files that include formatted content) is challenging.

The technology described herein can be used to process files in the binary format to generate a plurality of files that are compatible with big data tools (e.g., files in a non-binary format). This in turn can allow binary files to be analyzed using the big data tools. As used in this document, a binary file refers to a computer file that includes not only textual content, but also formatting and/or processing information associated with the textual content. Examples of binary files include spreadsheets that include textual content such as values, together with formatting/processing information such as one or more of: formulas, links, queries, application codes (e.g., Visual Basic for Applications (VBA) codes) and macros.

In some implementations, the technology described herein is used to extract spreadsheet meta-data, such as number of formulas, macros, links, queries, errors, warnings, and analysis or auditing data, and store the extracted data in a traditional relational database. In some implementations, meta-data related to cell-level audit trails can be generated and stored in the relational database. In some implementations, data from a spreadsheet may be stored in a relational database using, for example, a plugin tool. In some implementations, the extracted meta-data, together with the textual data from the spreadsheet, can be stored in another storage location (e.g., as one or more text files) accessible to one or more big data tools. This way, the textual data from the spreadsheet, as well as the meta-data associated with the spreadsheet can be processed via big data analytics. The big data tools can therefore be used to analyze the textual data from the spreadsheet and the meta-data, for example, to provide meaningful insights to data stored within the spreadsheets. For large organizations and companies that store their data, for example, within thousands or even millions of interconnected spreadsheets, such analytical capabilities can help drive effective business improvements and achieve better business performance. By providing an ability to analyze spreadsheets or other binary files via large scale distributed processing systems, the technology described herein may generate insights that might be missed otherwise. For example, allowing spreadsheets to be analyzed by the big data tools can result in detection of patterns, errors, warnings and fraud which may help an organization (e.g. a corporation) improve productivity through spreadsheet analytics, and enhance compliance.

The technology described herein may provide one or more of the following advantages. For example, the various underlying components of binary files such as spreadsheets may be converted into formats that are compatible with big data tools. In some implementations, various components of a spreadsheet, e.g., cell data, formulas, queries, links, VBA code and macros may be extracted from the corresponding spreadsheets and stored in files that can be analyzed using big data tools. Analysis of spreadsheet data (e.g. to identify errors, warnings and broken links) may be performed, and this information may be included in files compatible with big data tools. In some implementations, a relational database may be converted into a format compatible with big data tools. In some implementations, updates to the spreadsheet may be captured in real time or near real-time to ensure that the analyses are accurate and current. Spreadsheet data and meta-data from a big data database may be analyzed to drive actionable insight that may drive improved business performance.

In some implementations, the files generated from the spreadsheets may be made searchable using the big data tools. For example, users may search for and retrieve keywords within a large number (e.g., millions) of spreadsheets using the big data tools. Users may also search through millions of records of spreadsheet data and meta-data collected by other applications. In some implementations, generating component files from spreadsheets can be facilitated using a connector module that is integrated within an application for the spreadsheets. For example, the connector module can be provided as a plugin to Microsoft Excel to generate component files in a format that is compatible with big data tools. Such a connector module can therefore be used to leverage analytics capabilities of the big data tools to analyze data in the Excel spreadsheets.

In some implementations, the technique described herein can be applied to other binary file formats such as drawings. For example, drawing data, such as a list of drawing objects and their attributes, blocks, layers, colors, line thickness, drawing orientation, external references (xrefs), and co-ordinates, may similarly be stored as a plurality of files in a format compatible with big data tools.

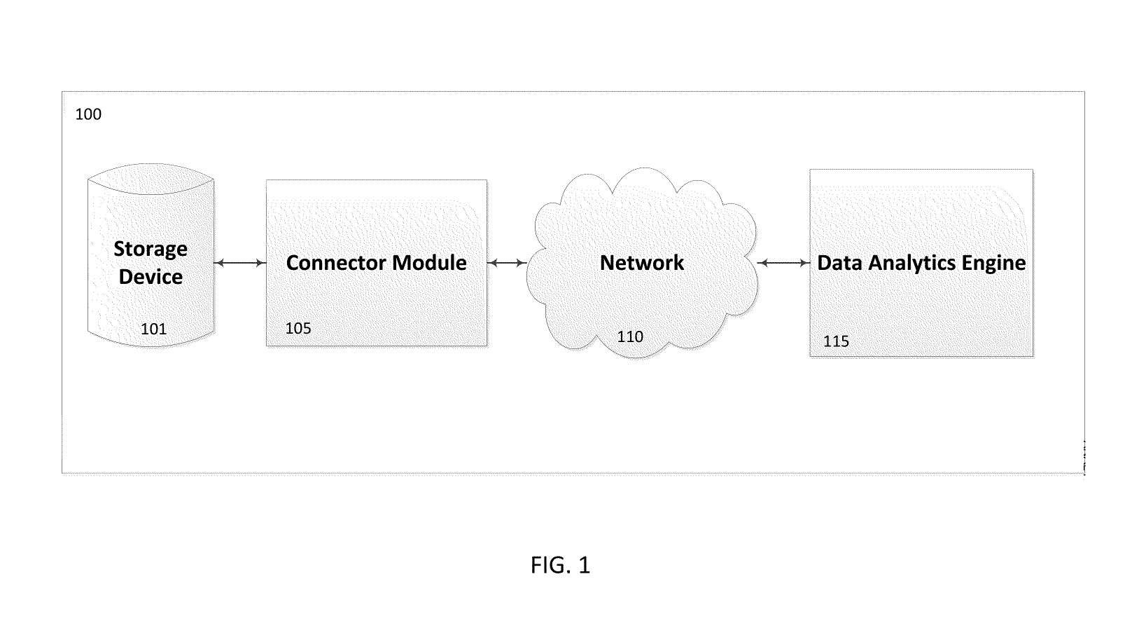

FIG. 1 depicts an environment 100 that facilitates analysis of computer-readable files such as spreadsheets. The environment 100 can includes a storage device 101 that stores binary files such as spreadsheets. The binary files may be organized within the storage device 101 as files or as one or more databases. The environment 100 also includes a data analytics engine 115 that can be used to analyze the binary files stored within the storage device 101. In some implementations, the data analytics engine 115 can include big data tools. For example, the data analytics engine can include a framework (e.g., Apache Hadoop) for running applications on a large cluster of distributed computing devices. The environment 100 further includes a connector module 105 that interfaces between the storage device 101 and the data analytics engine, possibly over a network 110.

The connector module 105 can be configured to analyze binary files (e.g., spreadsheets) stored in the storage device 101 to generate one or more files in a format compatible with the data analytics engine 115. In some implementations, the connector module 105 can be implemented on a computing device in communication with the storage device 101. The computing device can be configured to access binary files (e.g., spreadsheets) stored in the storage device 101 and generate corresponding files in a format that can be processed by the data analytics engine 115. In some implementations, the connector module can be implemented as a plugin for an application used for accessing the spreadsheets. For example, the connector module 105 can be provided as a plugin to Microsoft Excel to access Excel spreadsheets stored in the storage device 101 and generate text files from the Excel spreadsheets. The connector module 105 can also be configured to store the generated files in a location accessible to the data analytics engine 115. In some implementations, the connector module 105 can be configured to store the generated files in the storage device 101 or another storage device that is accessible to the data analytics engine 115 over the network 110.

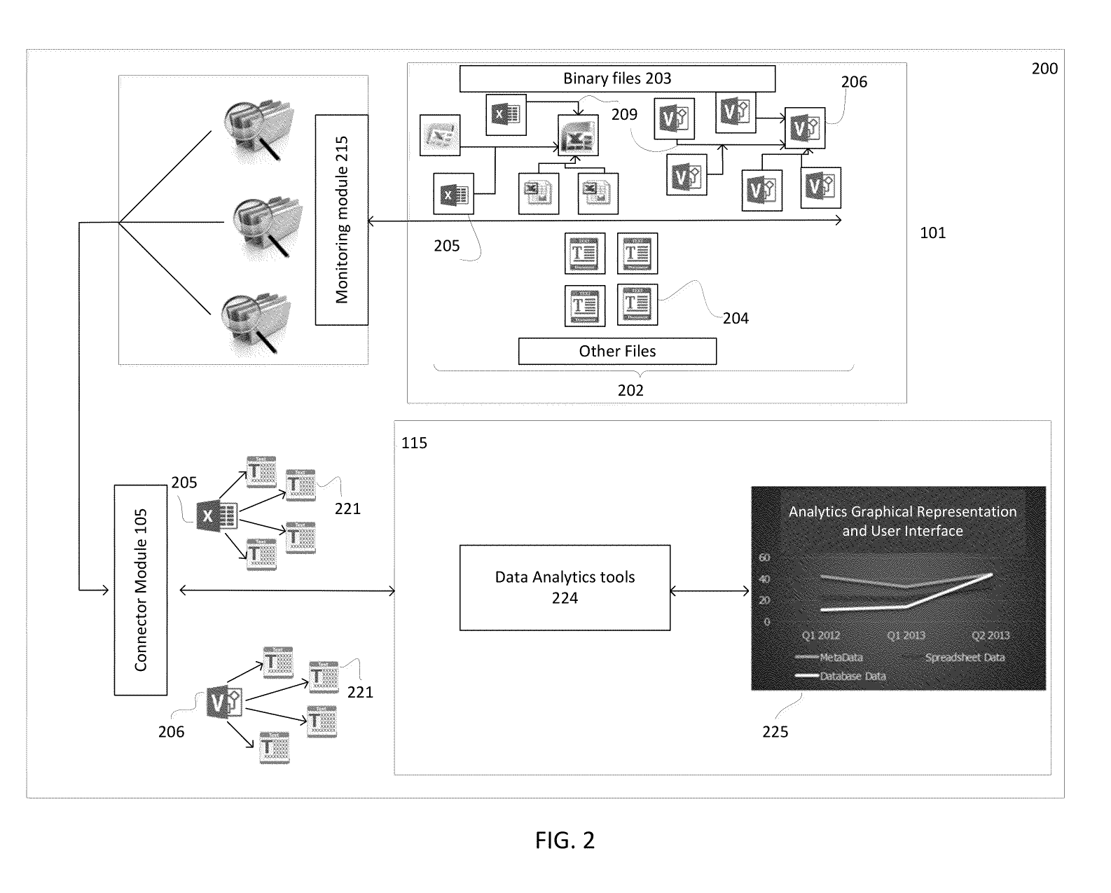

FIG. 2 shows a system 200 for implementing the technology described herein. The system 200 includes the storage device 101 may contain stored data 202. In some implementations, stored data 202 may be organized as a data structure or database. For example, the storage device 101 can include a file system such as the New Technology File System (NTFS). In some implementations, the storage device 101 can include Network-Attached Storage (NAS) network drives. In some implementations, the storage device 101 can include a document and file management system such as Microsoft Sharepoint. In some implementations, the storage device 101 can be a part of a distributed storage system such as cloud storage. The stored data 202 can be stored, for example, as a part of at least one of a relational database, a hierarchical database, a network database, and an object-oriented database.

The stored data 202 may include a plurality of files of various types. For example, the stored data 202 may include binary files 203, e.g., spreadsheet files 205, drawing files 206, word-processor files, web data, mobile data, and other files that include both textual as well as formatting information. The stored data 202 can also include non-binary files 204 such as text files. In some implementations, a large number of files (e.g., thousands or millions of files) may be stored within the storage device 101. In some implementations, the binary files 203 can have dependencies 209 on each other. For example, a spreadsheet file 205 may have a formula that accepts a value from another spreadsheet file and uses the value for a calculation. Other examples of such dependencies 209 can include spreadsheet links and queries.

In some implementations, it could be desirable to analyze the files stored in the storage device 101 using large scale distributed systems (e.g., massively parallel distributed systems running on tens, hundreds, or even thousands of servers) to glean meaningful information that is challenging to obtain using local or small scale database management systems. For example, it could be desirable to analyze files stored within the storage device 101 using big data tools such as provided by an Apache Hadoop framework. The technology described herein facilitates creation of a plurality of non-binary files (e.g., text files) from a binary file such that the plurality non-binary files together represent the corresponding binary file. The plurality of non-binary files is amenable to processing by large scale distributed systems, thereby allowing for the binary files to be processed by such systems. This results in binary files such as spreadsheets, drawings and word processor files being converted to a format that can be processed using big data tools such as provided by an Apache Hadoop framework.

The plurality of non-binary files created from a binary file can be configured such that the non-binary files store information about the corresponding binary file in a textual format. For example, apart from textual information such as values and strings, a spreadsheet can include various types of information related to the textual content. For example, a spreadsheet 205 can include information on cell data (e.g., the location of a given portion of textual data within the spreadsheet), link information (e.g., whether a given cell or value within a spreadsheet is linked to another cell or even another spreadsheet), macro classes (e.g., user-defined objects which are created for a workbook), macro modules (e.g., codes associated with a spreadsheet), formulae (e.g., mathematical or logical operations on one or more portions of the textual content), and queries. In some implementations, the connector module 105 can be configured to create a plurality of non-binary files 221 from the spreadsheet 205 such that the various types of information related to the spreadsheet are stored in the non-binary files.

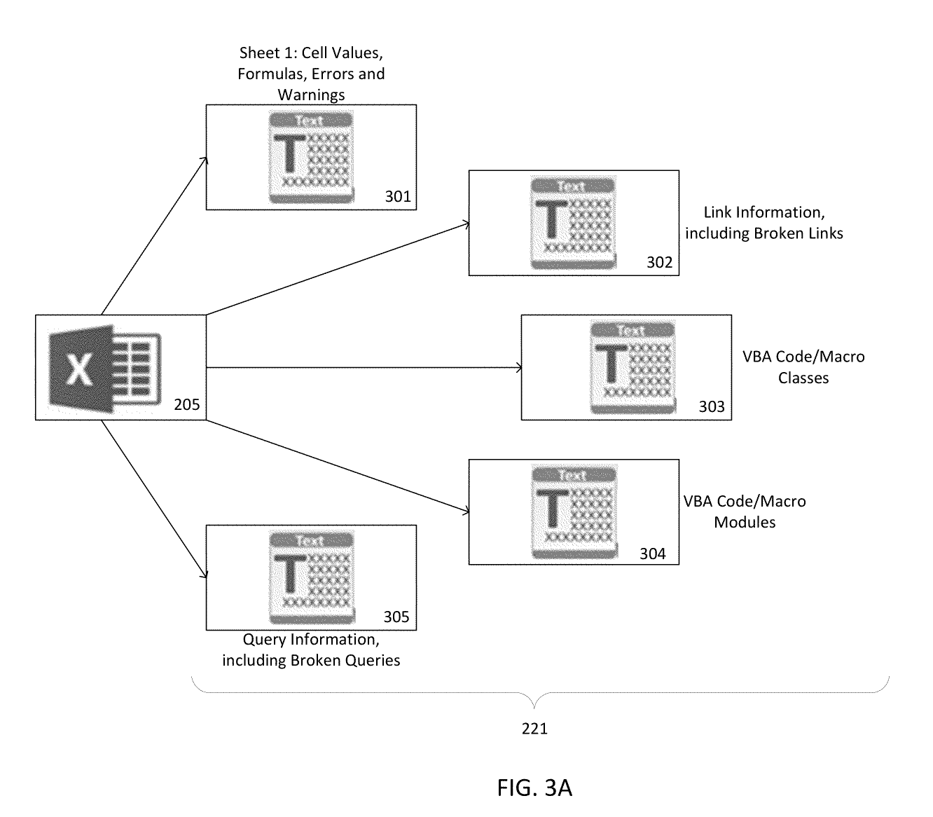

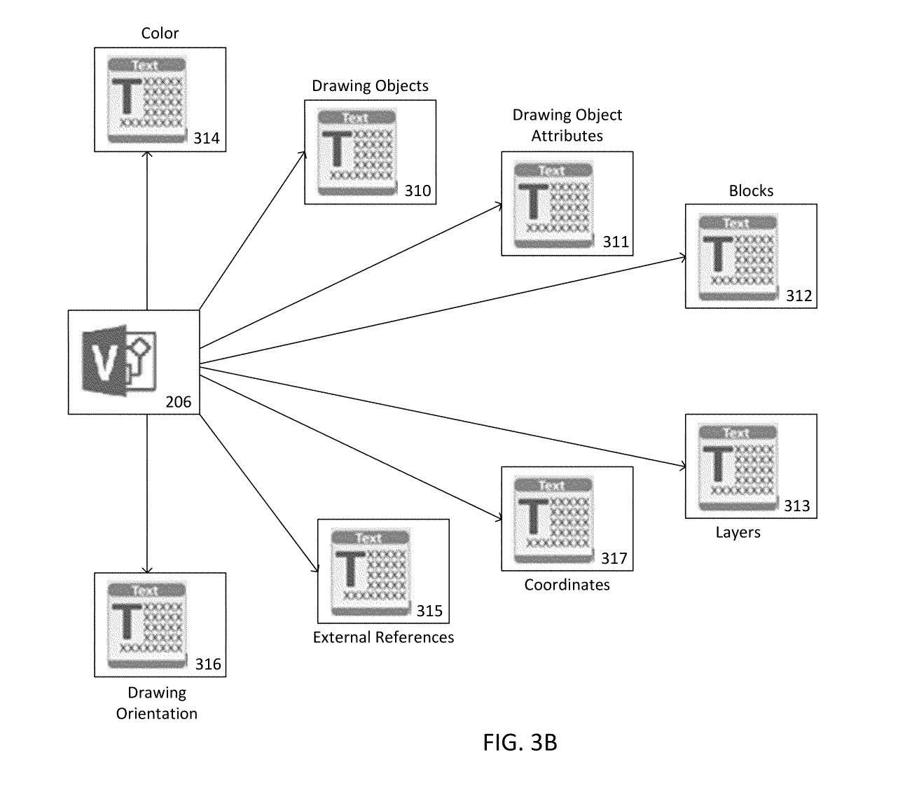

FIG. 3A shows examples of non-binary files 221 created from a binary spreadsheet file 205. In this example, the non-binary files 221 include a text file 301 that stores cell data, a text file 302 that stores link information, a text file 303 that stores information on macro classes, a text file 304 that stores information on macro modules, and a text file 305 that stores query information. In some implementations, the text file 301 storing cell data can include numerical values, text, symbols, formulas, or any combination of these. A formula may be any combination of numbers, letters, symbols, or references to other cells entered in a cell and formatted in a way such that a result can be calculated (or otherwise another action can be taken) based on the formula. In some implementations, one or more of the formulae, formatting instructions, errors and warnings can be stored in separate respective text files.

The text file 302 can include, for example, information describing where a cell is linking and whether a link is broken. The link information can also include a formula that initiates data retrieval from another cell, possibly in another spreadsheet file. Link information can also include information whether or not a link is pointing to useable cell data. A link may become broken, for example, when the spreadsheet file that the link is pointing to is moved, renamed, deleted, or corrupted.

The text file 303 can include, for example, the macro classes created for a spreadsheet and underlying event-driven programming language code, such as VBA code, or project associated with the macro classes. A macro class can include a user-defined object that has been created for a workbook. Such objects can be used elsewhere in the spreadsheet, for example, in macro modules. A macro class may be written using Visual Basic for Application (VBA) code, and stored in association with the corresponding spreadsheet.

The text file 304 can include, for example, information on one or more macro modules created/defined for the spreadsheet 205 and the underlying event-driven programming language codes, such as a VBA code, or information on a project associated with the macro modules. A macro module can include code associated with a spreadsheet. Macro modules may be created, for example, by a user to automate spreadsheet tasks and perform spreadsheet functions. A macro module can be written, for example, using Visual Basic for Application (VBA) code, and stored in association with the corresponding spreadsheet.

The text file 305 can include, for example, information on queries associated with the spreadsheet, e.g., what is being queried, and whether the query is proper. In some implementations, a query can include a function that retrieves data from a source external to the spreadsheet. The retrieved data may then be used within the spreadsheet. For example, a query can be configured to retrieve data from an external database such as a corporate database. In some implementations, when an external data source is updated, a query referring to the external data source may automatically retrieve the updated data.

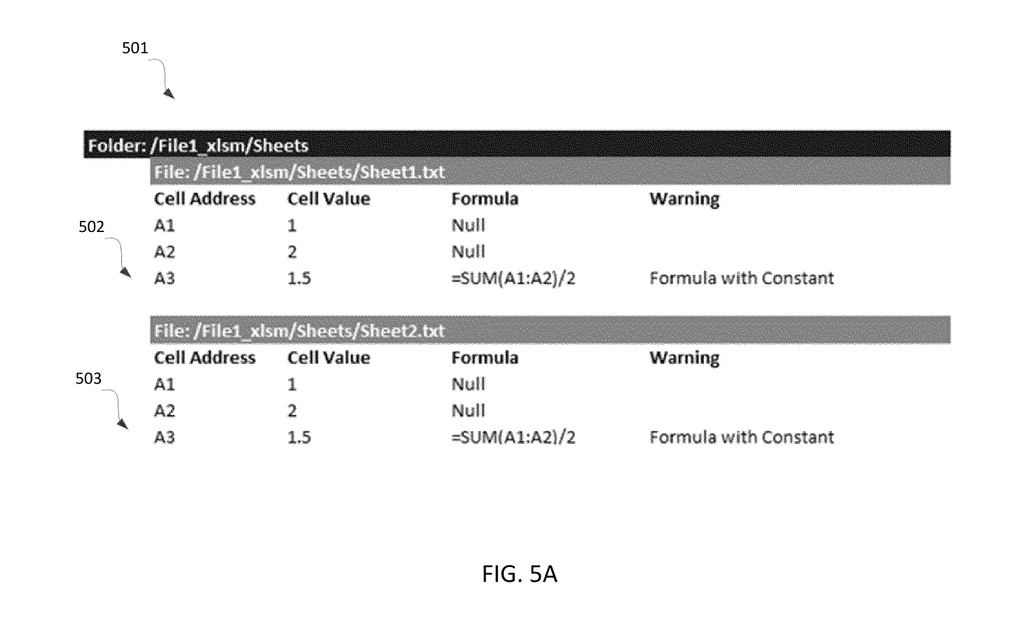

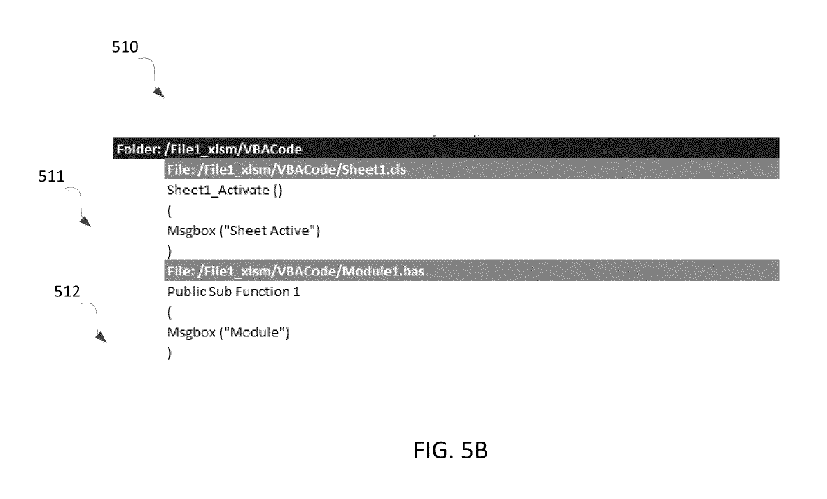

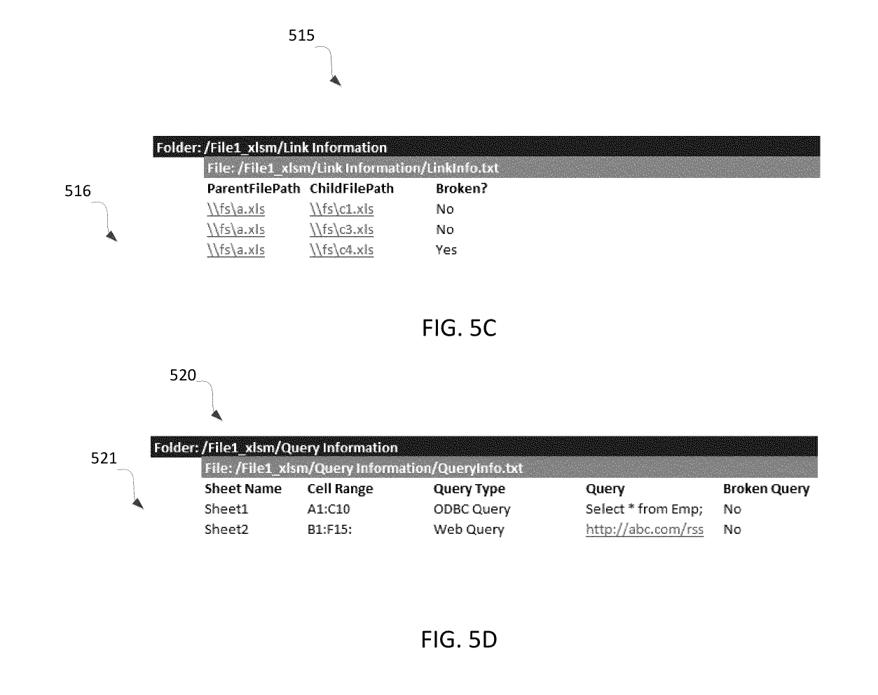

FIGS. 5A-5D show examples of folder and file names for components of an analyzed spreadsheet file 205. FIG. 5A shows an example of a folder 501 and files 502 and 503 for storing cell values and formulae. FIG. 5B shows an example of a folder 510 and files 511 and 512 for storing description of VBA codes. FIG. 5C shows an example of a folder 515 and a file 516 for storing information related to links. FIG. 5D shows an example of a folder 520 and a file 521 for storing queries.

FIG. 3B shows another example with respect to a binary drawing file 206. In this example, the text files 310-317 created from the drawing file 206 each includes information on various components and attributes associated with the drawing file 206. For example, the text file 310 can include information on drawing objects (e.g., predefined shapes, connectors, etc.), the text file 311 can include information on drawing object attributes (e.g., shades, size etc.), the text file 312 can include information on blocks (e.g., which objects are grouped together), the text file 313 can include information on layers (e.g., how the various objects overlap), the text file 314 can include information on various colors associated with the drawing 206, the text file 315 can include information on external references (xrefs) of the drawing file, the text file 316 can include information on drawing orientation, and the text file 317 can include information on coordinates or positions of the various objects within the drawing. FIGS. 3A and 3B are shown for illustrative purposes. More of less number of non-binary files (e.g., text files) can be created from a binary file such as a spreadsheet or drawing based on, for example, number of attributes of the binary file used in subsequent analyses by the data analytics engine 115. In some implementations, the non-binary files illustrated in FIGS. 3A and 3B can include comma-separated-values (csv) files. The text or csv files can be stored under a folder name that is reflective of the original spreadsheet file name.

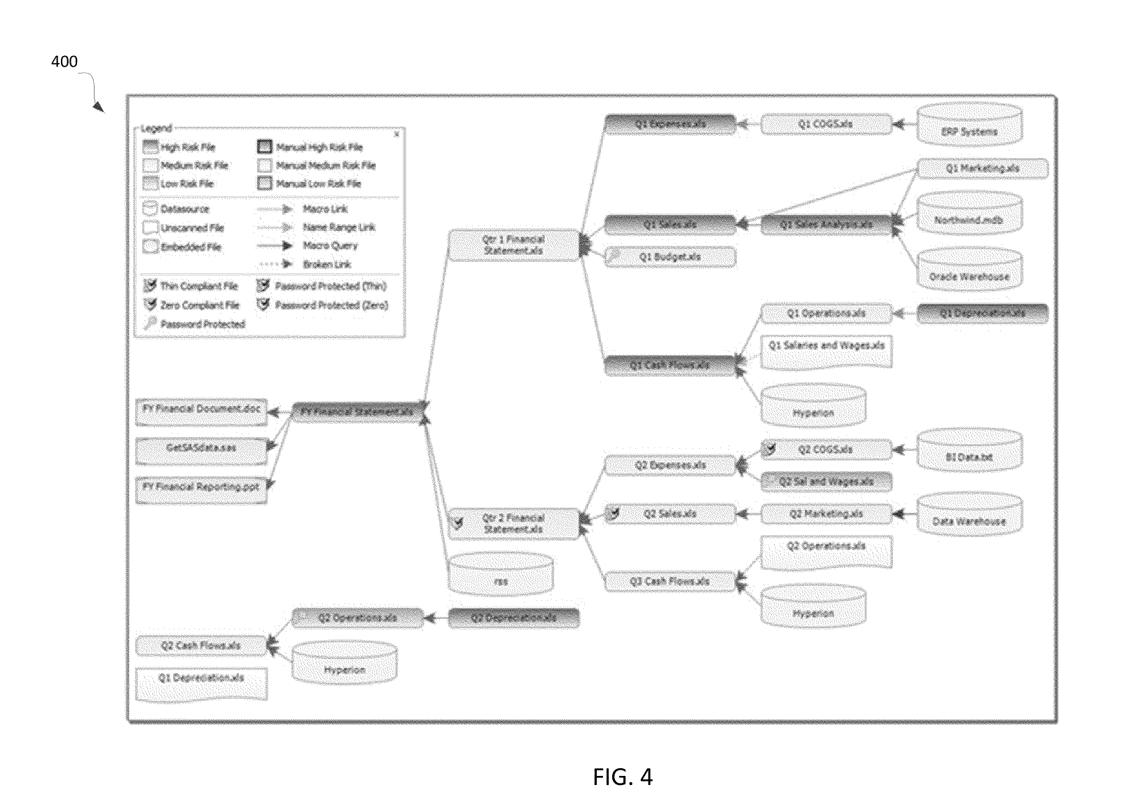

In some implementations, the connector module 105 can be configured to analyze the binary files 203, for example, to detect sources of potential errors and/or discrepancies. For example, spreadsheets stored within the storage device 101 can be analyzed by the connector module to detect errors, warnings, broken links, or broken queries. In some implementations, the analysis results can be graphically represented via a user interface such as the End-User-Computing (EUC) map 400 depicted in FIG. 4.

In some implementations, the system 200 can include a monitoring module 215 that monitors or scans the storage device 101 for binary files that can be provided to the connector module 105. In some implementations, the monitoring module 215 may scan the storage device automatically (e.g., periodically) to look for new binary files that may have been stored in the storage device since the last scan. In some implementations, the monitoring module may be launched based on detecting a change to one or more files. For example, as soon as a file is added, modified, renamed, moved or deleted, the monitoring module may identify the event and pass the information on to the connector module 105. In some implementations, the monitoring module 215 may be launched based on receiving a user input.

In some implementations, the connector module 105 can be configured to store the non-binary files at a storage location that is accessible by the data analytics engine 115. For example, the connector module 105 can be configured to store the non-binary files in the storage device 101. The non-binary files can also be stored on a different local or remote storage device such as a cloud storage location accessible by the data analytics engine 115. In some implementations, the data analytics engine 115 may access the storage location via the network 110 as described with reference to FIG. 1.

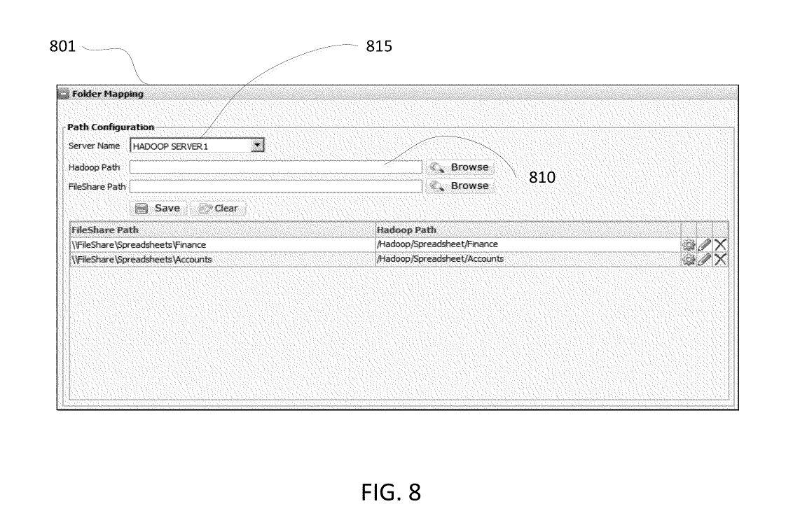

In some implementations, a storage location for the non-binary files 221 can be specified by a user via a user interface provided by the connector module 105. The interface may be referred to as an application configurator, and example of which is shown in FIG. 8. In the example of FIG. 8, the application configurator 801 can be used to define network drives, servers, and/or folders where the non-binary files 221 are stored. In some implementations, the application configurator 801 can be used to specify the resources (e.g., servers, drives, folders, or files) that are to be made accessible to the data analytics engine 115. This can be done, for example, via a control 810, e.g., a file path input field, a drop down menu, or another selectable control. In some implementations, the application configurator 801 can be used to specify the storage locations that are to be monitored by the monitoring module 215. In some implementations, the application configurator 801 can be configured to enable a user to select the data analytics engine (e.g., the server housing the engine) via a control 815, such that the selected engine is provided access to the storage location where the non-binary files 221 are stored.

The data analytics engine 115 includes a set of data analytics tools 224 that can process the non-binary files 221. The data analytics tools 224 can include, for example, a combination of software and hardware modules capable of processing large volumes of non-binary files 221. For example, the data analytics tools 224 can include big data tools such as tools provided within an Apache Hadoop framework. For example, the data analytics tools 224 can include a centralized control module for maintaining configuration information, naming, providing distributed synchronization, and providing group services with respect to the files accessed by the data analytics engine 115. An example of such a centralized control module includes ZooKeeper, which is provided within a Hadoop framework.

The data analytics tools 224 can also include a distributed file system such as the Hadoop Distributed File System (HDFS), which is a Java-based file system that provides scalable and reliable data storage designed to span large clusters of commodity servers over which the Hadoop framework is deployed. Such a distributed file system can spread multiple copies of the accessed files and data across different computing devices such as servers. In some implementations, this can increase reliability and provide multiple locations to run mapping processes for managing the data. Because of such redundancy, if a machine with one copy of the data is busy or offline, another machine can be used. The data analytics engine 115 can also include a plurality of hardware storage locations possibly distributed over multiple servers.

The data analytics tools 224 can also include a distribution engine such as the Hadoop MapReduce engine that distributes computing tasks around a cluster of computing devices. In some implementations, a job scheduler such as Hadoop Job Tracker can keep track of jobs being executed by the data analytics engine 115. In some implementations, the data analytics tools can include a large-scale database management system such as the HBase system provided within the Apache Hadoop network.

The data analytics tools 224 can also include a data warehouse module that facilitates querying and managing large datasets residing in the distributed file system. Example of such warehouse module includes The Apache Hive™ data warehouse system provided within the Apache Hadoop framework. The data analytics tools 224 can also include a large-scale log collection and analysis module such as Chukwa. Such a collection and analysis module can include, for example, a toolkit for displaying, monitoring and analyzing various results based on data by the data analytics engine. The data analytics tools can also include one or more programming tools (e.g., Apache Pig) that are compatible with the framework of the data analytics engine 115.

In some implementations, one or more of the data analytics tools 224 processes the accessed data to provide results such as actionable insights. The results can be provided in the form of raw data or within a graphical user interface 225. In some implementations, the results are provided to the connector module 105 over the network 110 described with reference to FIG. 1.

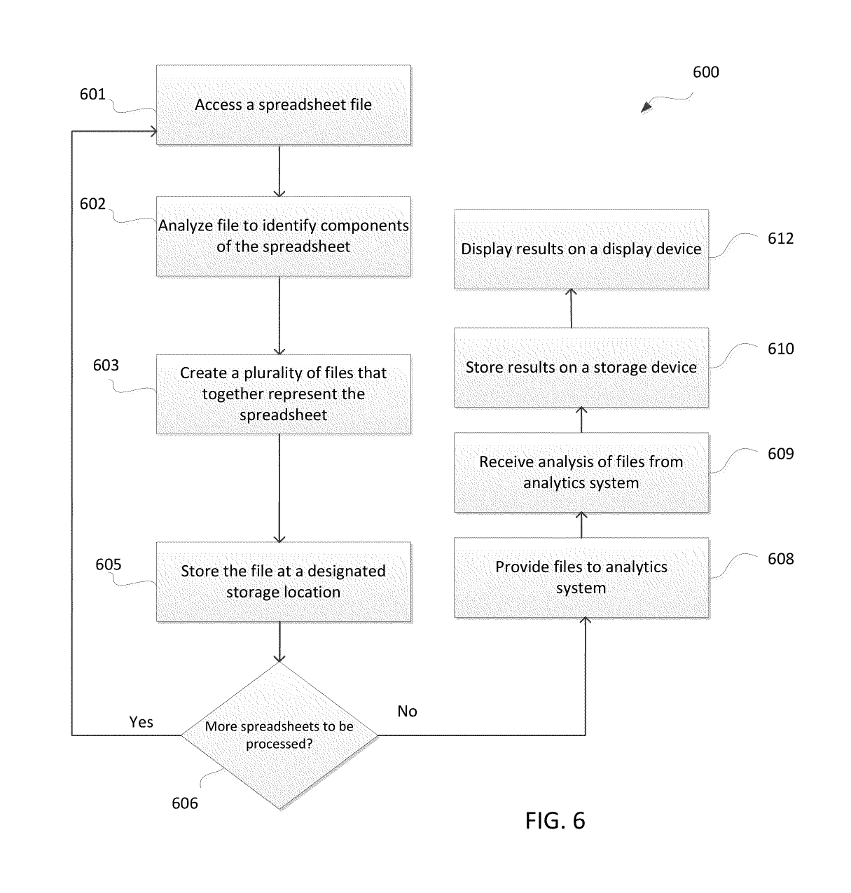

FIG. 6 is a flowchart depicting an example sequence of operations 600 for creating non-binary files from binary spreadsheet files. One or more operation of the sequence 600 can be performed, for example, on a computing device associated with the connector module 105 described with reference to FIG. 2. The operations include accessing a spreadsheet file (601). The spreadsheet file can be accessed, for example, from the storage device 101. In some implementations, the spreadsheet file can be accessed via the monitoring module 215 described with reference to FIG. 2. For example, a spreadsheet file 205 stored within the storage device 101 may be analyzed by the monitoring module 215 and provided to the connector module 105. The operations also include analyzing the file to determine a plurality of components of the spreadsheet (602). The plurality of components can include at least two of (i) a component representing a data content of the at least one spreadsheet, (ii) a component representing one or more formulae associated with the at least one spreadsheet, (iii) a component representing one or more macros, (iv) a component representing one or more queries, and (v) a component representing links associated with the at least one spreadsheet. The plurality of components can include, for example, a component representing one or more codes in an event-driven programming language (e.g., Visual Basic for Applications (VBA)) associated with the spreadsheet.

The operations also include creating a plurality of files that together represent the spreadsheet (603). The plurality of files is created based on, for example, the components of the spreadsheet. Each of the plurality of files can be in a non-binary file such as a text file or a csv file. This can include for example selecting one or more components of the spreadsheet and creating a file corresponding to each of the selected components. Each of the plurality of files therefore corresponds to a particular component of the plurality of components. In some implementations, each of the plurality of files employs a format that is suitable for processing by an analytics system configured to process large-scale datasets stored among a plurality of storage devices. In some implementations, the analytics system is a Big Data analytics system. In some implementations, the volume of such large-scale datasets can be in the order of one of: petabytes (10¹⁵ bytes), zettabytes (10²¹ bytes), yottabytes (10²⁴ bytes) or brontobytes (10²⁷ bytes). The analytics system can include a framework (e.g., an Apache Hadoop framework) for processing the large-scale dataset. The operations further include storing the plurality of files at a storage location (605). In some implementations, the storage location can include a distributed file system associated with a framework for processing large-scale datasets.

In some implementations, the operations also include determining if additional spreadsheets are to be processed (606). If additional spreadsheets are to be processed, the next spreadsheet is accessed (601), and the operations 602, 603 and 605 may be repeated. The operations can optionally include providing the plurality of created files to the a data analytics engine (608) such as the data analytics engine 115 described with reference to FIGS. 1 and 2. Operations can also include receiving analysis results based on the plurality of files (609) and storing the results on a storage device (610). In some implementations, the results are displayed using one or more graphical user interfaces on a display device (612).

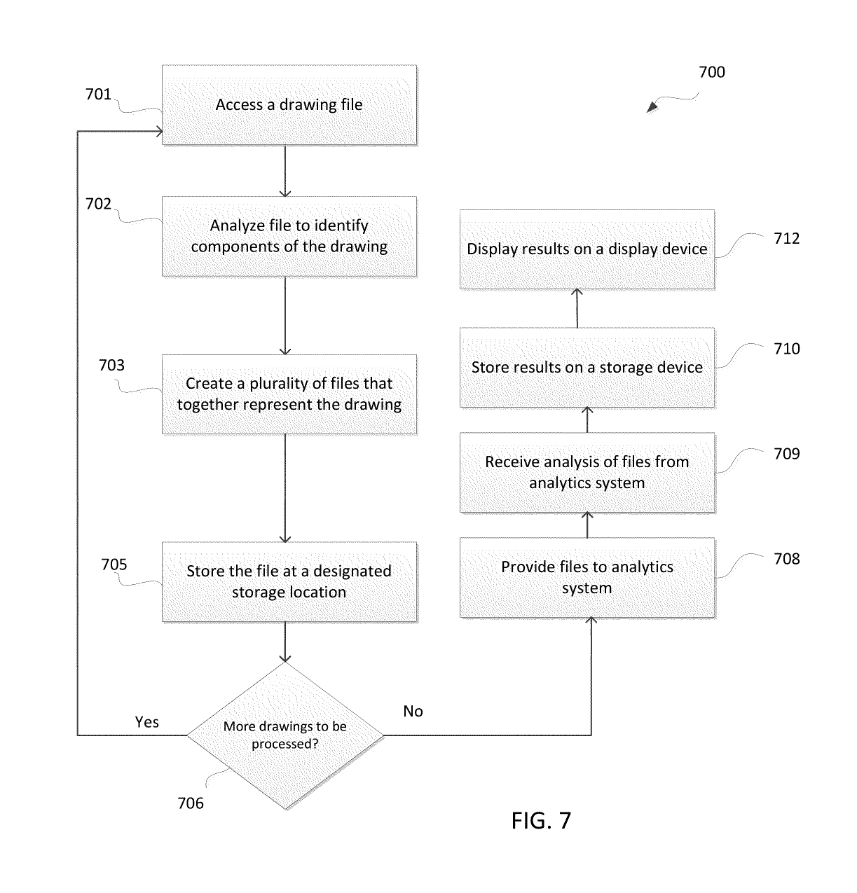

FIG. 7 is a flowchart depicting an example sequence of operations 700 for creating non-binary files from binary drawing files. One or more operation of the sequence 700 can be performed, for example, on a computing device associated with the connector module 105 described with reference to FIG. 2. The operations include accessing a drawing file (701). The drawing file can be accessed, for example, from the storage device 101. In some implementations, the drawing file can be accessed via the monitoring module 215 described with reference to FIG. 2. For example, a drawing file 206 stored within the storage device 101 may be analyzed by the monitoring module 215 and provided to the connector module 105. The operations also include analyzing the file to determine a plurality of components of the drawing (702). The plurality of components can include at least two of (i) a component representing an object and coordinates associated with the object, (ii) a component representing one or more layers, (iii) a component representing one or more colors, (iv) a component representing one or more blocks, and (v) a component representing one or more external references (xrefs).

The operations also include creating a plurality of files that together represent the drawing (703). The plurality of files is created, for example, based on the components of the drawings. Each of the plurality of files can be in a non-binary file such as a text file or a csv file. This can include for example selecting one or more components of the drawing and creating a file corresponding to each of the selected components. Each of the plurality of files therefore corresponds to a particular component of the plurality of components. In some implementations, each of the plurality of files employs a format that is suitable for processing by an analytics system configured to process large-scale datasets stored among a plurality of storage devices. In some implementations, the analytics system is a Big Data analytics system. In some implementations, the volume of such large-scale datasets can be in the order of one of: petabytes (10¹⁵ bytes), zettabytes (10²¹ bytes), yottabytes (10²⁴ bytes) or brontobytes (10²⁷ bytes). The analytics system can include a framework (e.g., an Apache Hadoop framework) for processing the large-scale dataset. The operations further include storing the plurality of files at a storage location (705). In some implementations, the storage location can include a distributed file system associated with a framework for processing large-scale datasets.

In some implementations, the operations also include determining if additional drawings are to be processed (706). If additional drawings are to be processed, the next drawing in accessed (701), that the operations 702, 703 and 705 may be repeated. The operations can optionally include providing the plurality of created files to the a data analytics engine (708) such as the data analytics engine 115 described with reference to FIGS. 1 and 2. Operations can also include receiving analysis results based on the plurality of files (709) and storing the results on a storage device (710). In some implementations, the results are displayed using one or more graphical user interfaces on a display device (712).

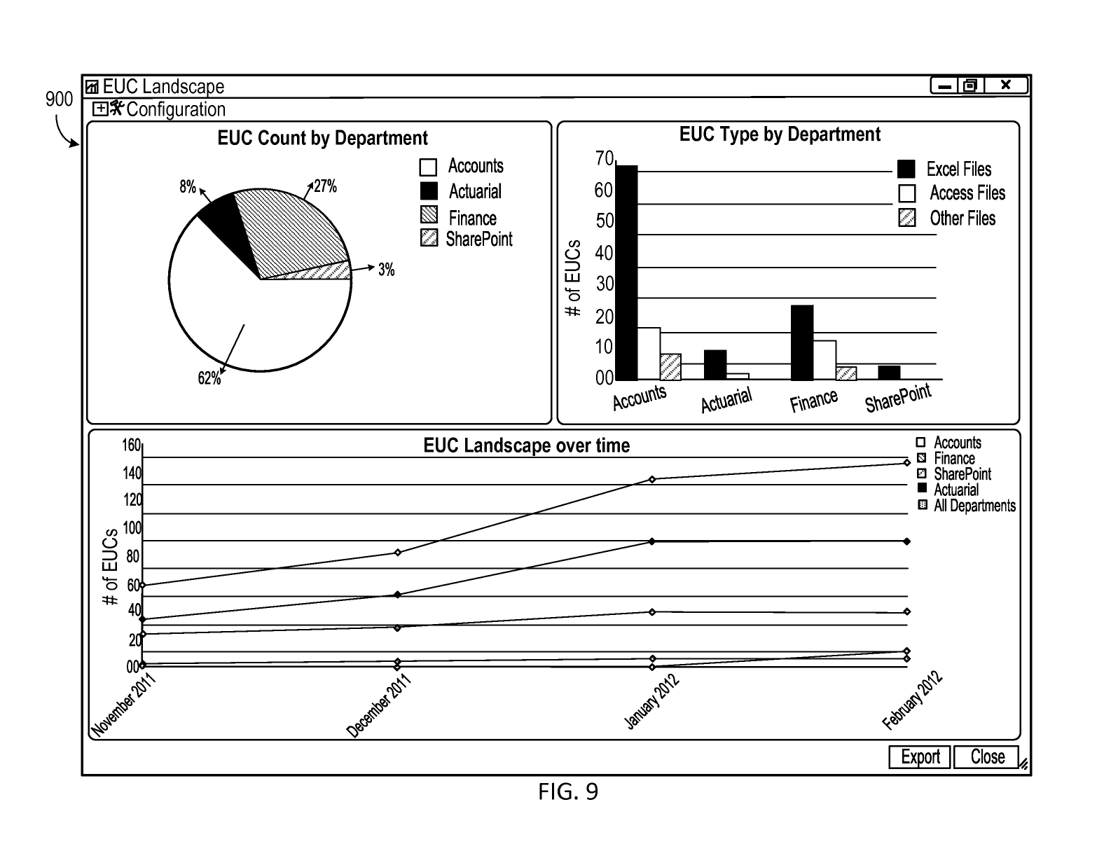

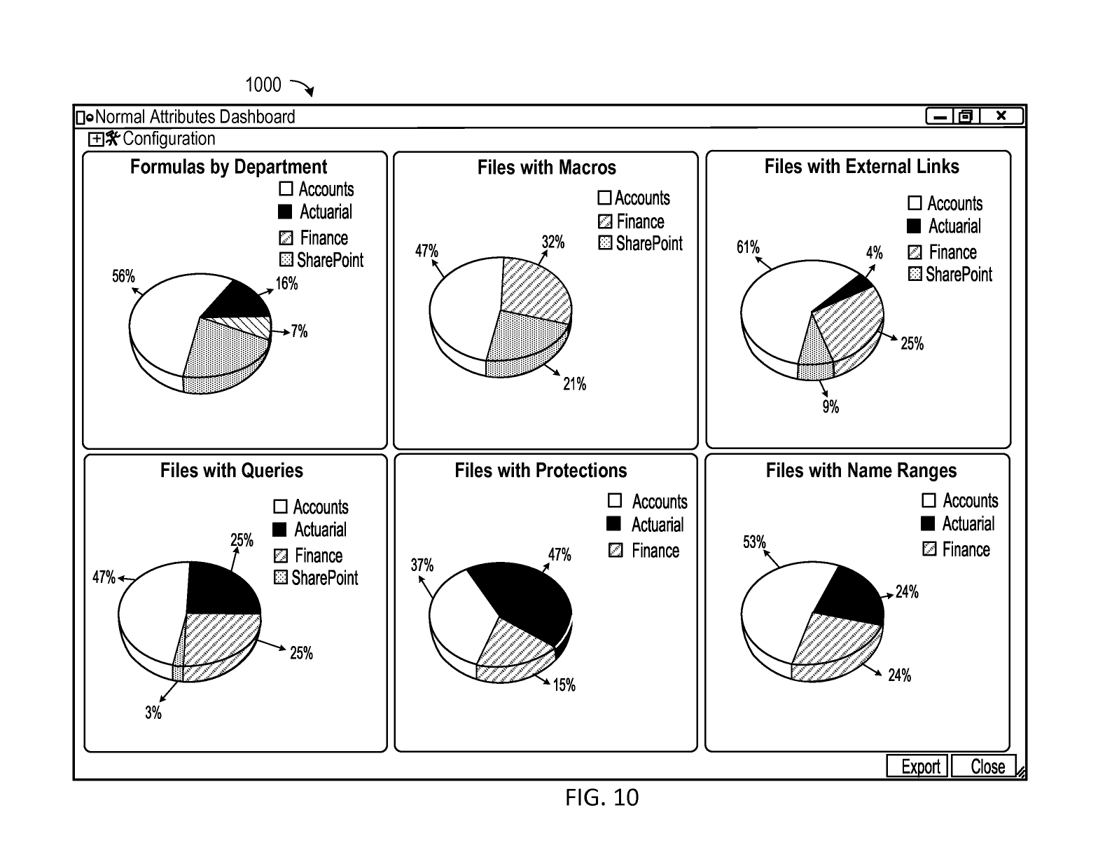

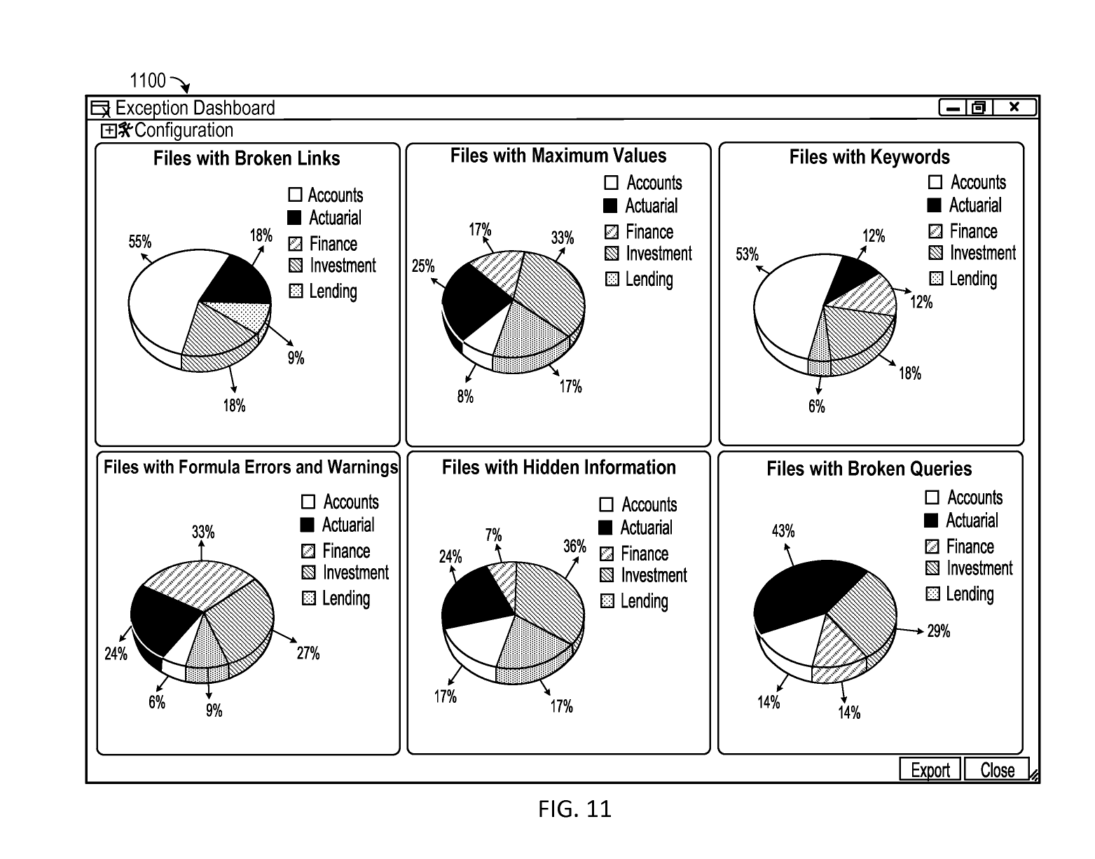

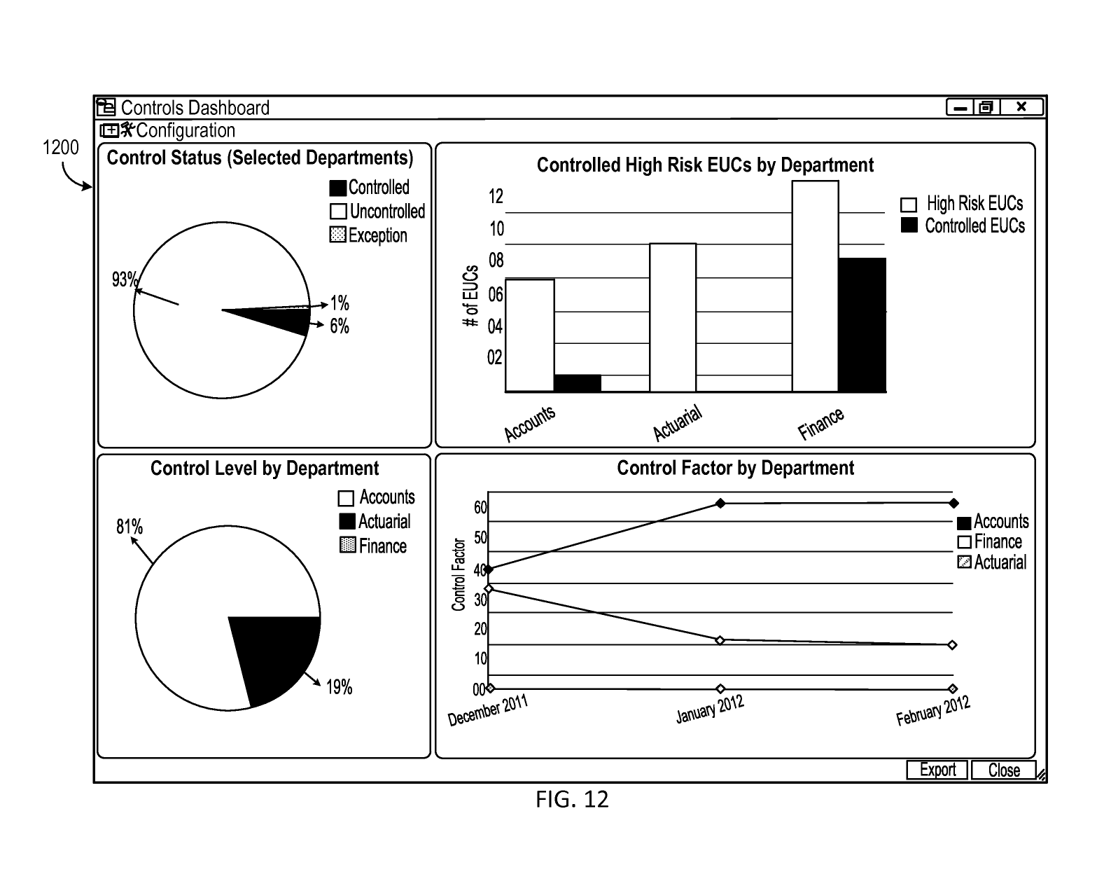

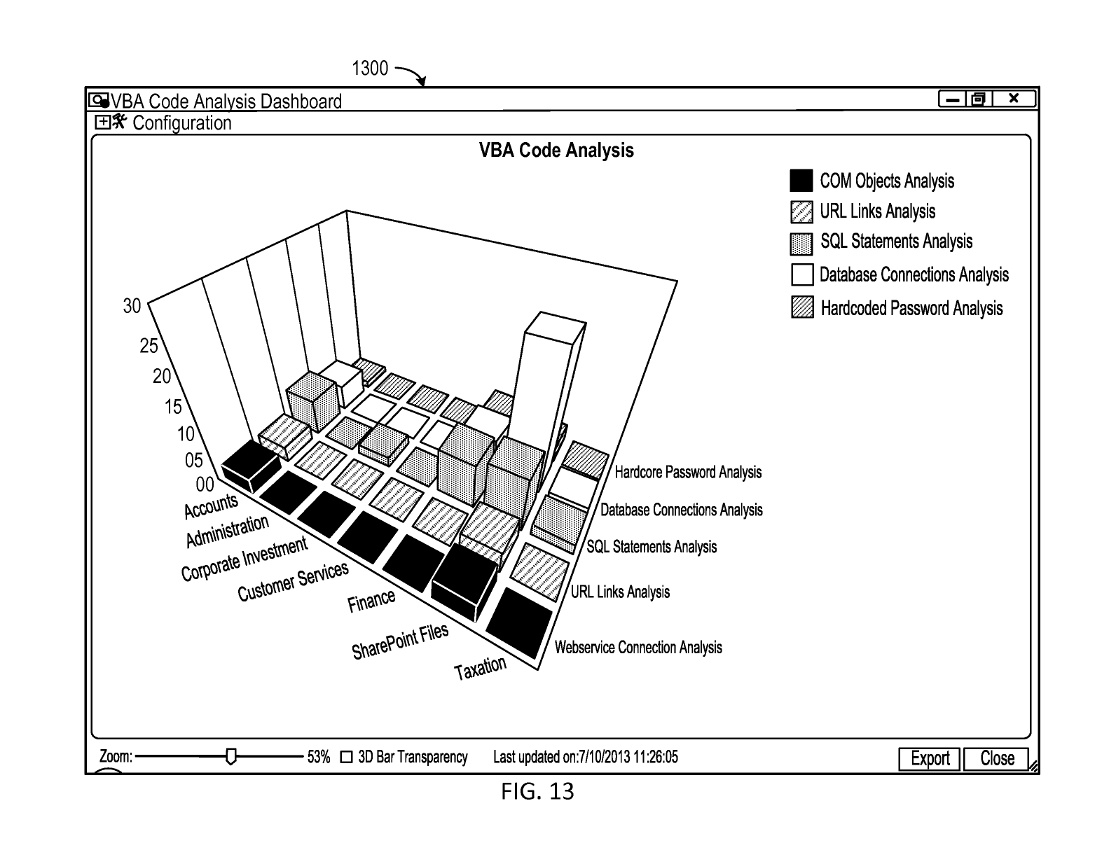

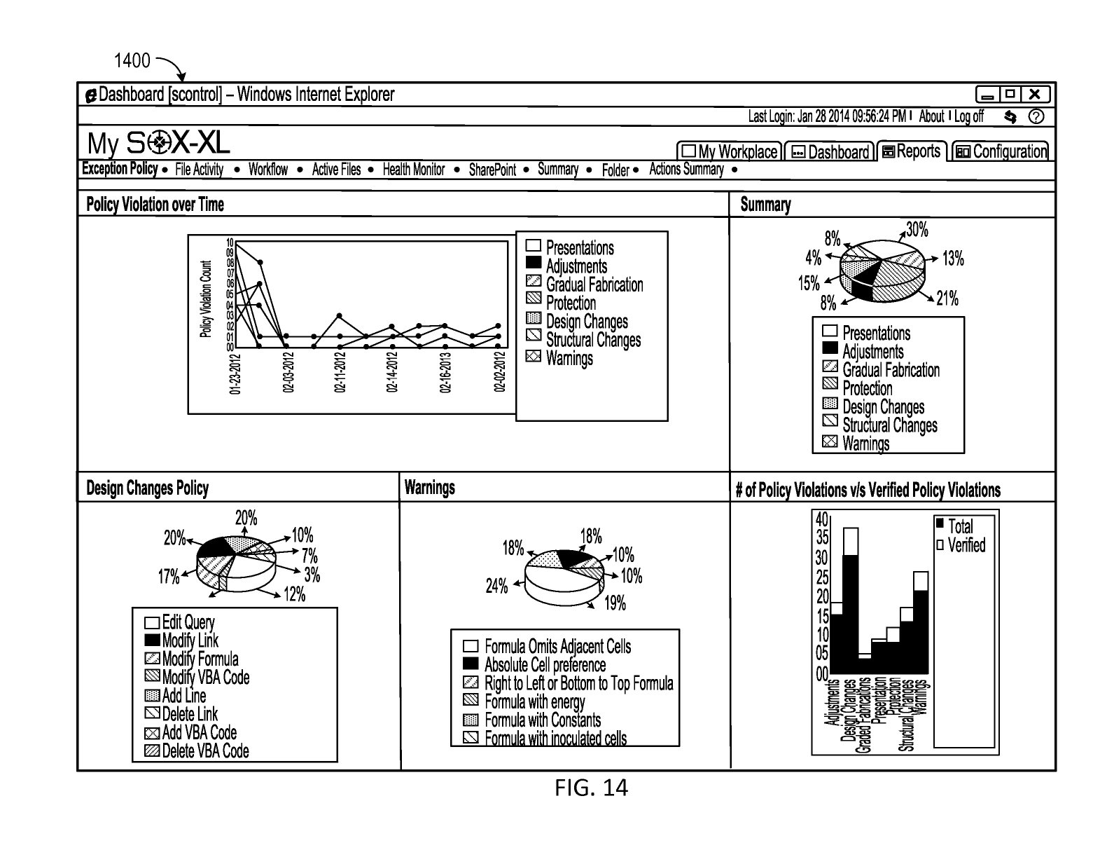

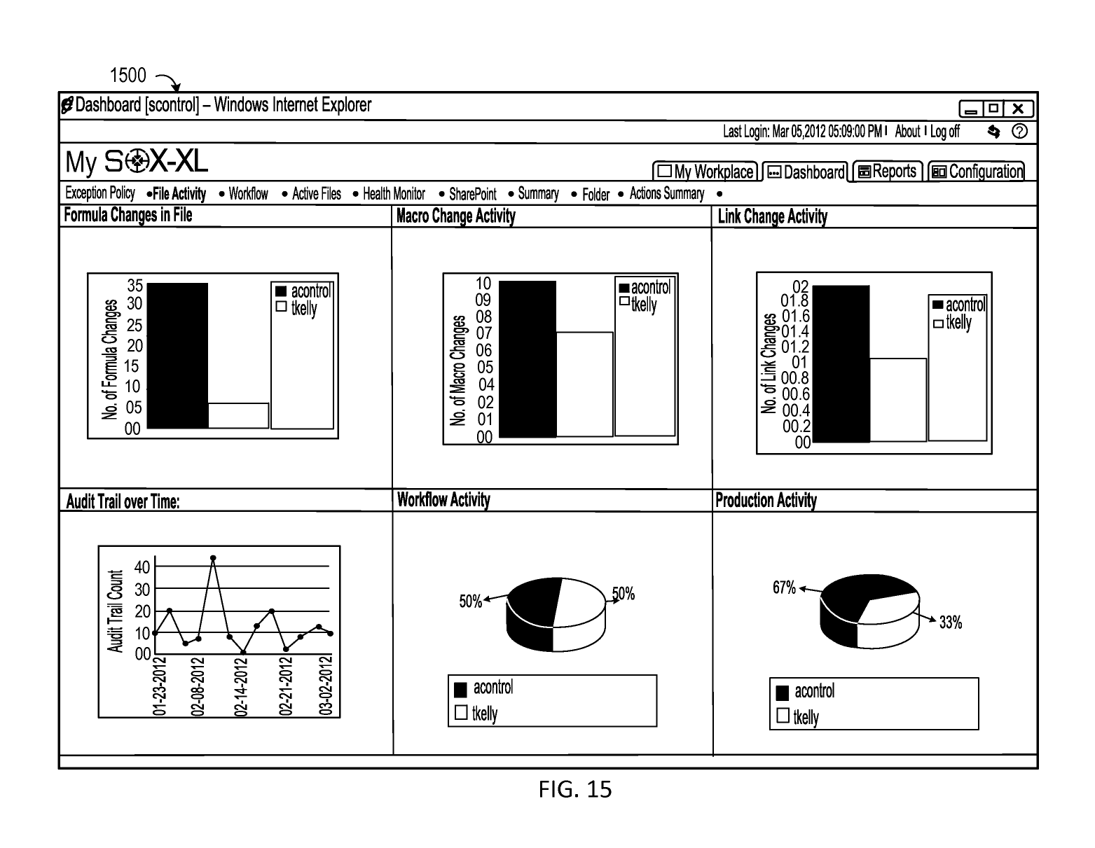

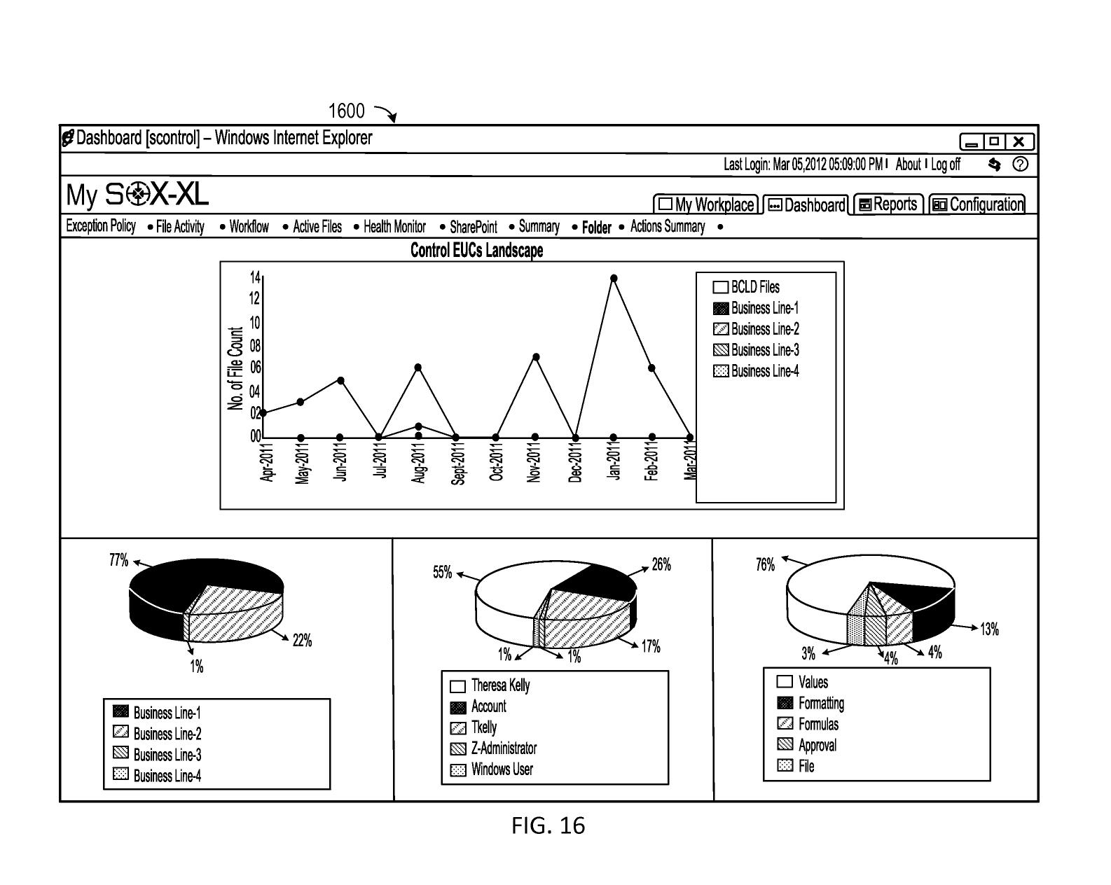

FIGS. 9 through 16 show various examples of user interfaces showing results provided by the data analytics engine 115. FIG. 9 shows a user interface 900 showing graphical representation of an inventory of all files belonging to an organization. FIG. 10 shows a user interface 1000 depicting a graphical representation of various file attributes. FIG. 11 shows a user interface 1100 depicting distribution of spreadsheets with potential issues. FIG. 12 shows a user interface 1200 depicting a graphical representation of assessments of compliance. FIG. 13 shows a user interface 1300 depicting a three dimensional graphical representation of distribution of VBA codes. FIG. 14 shows a user interface 1400 depicting a graphical representation of a dashboard which allows the user to change or monitor policy violations within an organization. Any violations of company policy, such as the use of invisible cells or text, can be monitored via this dashboard. FIGS. 15 and 16 show user interfaces 1500 and 1600, respectively, each depicting a graphical representation of file activities within an organization.

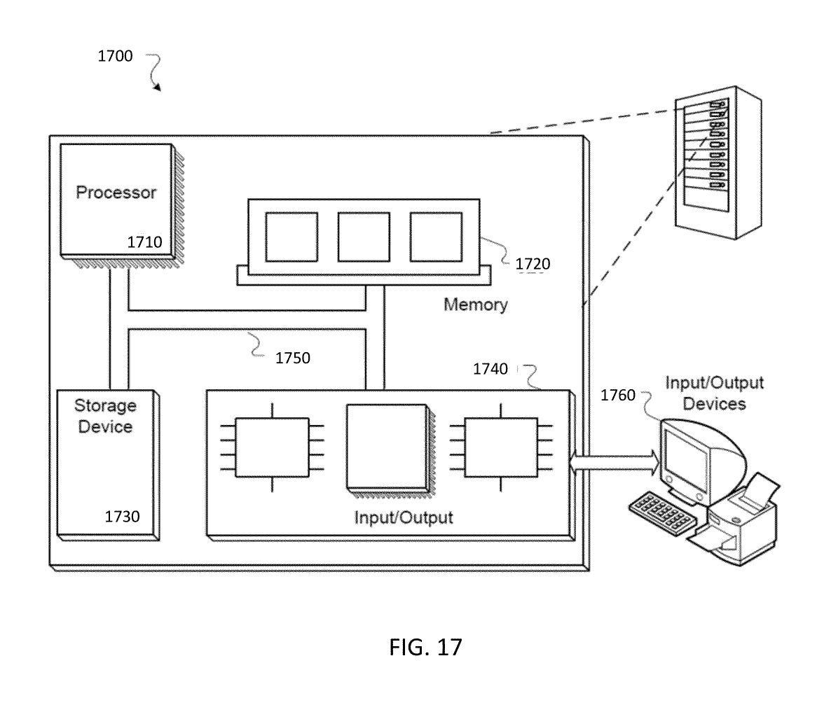

FIG. 17 is a block diagram of an example computer system 1700 that may be used in implementing the technology described in this document. For example, one or more of the storage device 101, the connector module 105, the data analytics engine 115, and the monitoring module 215 may include at least a portion of the system 500 described here. General-purpose computers, network appliances, mobile devices, or other electronic systems associated with the users may also include at least portions of the system 1700. For example, the user interfaces described with respect to FIGS. 8-16 may be displayed on a computer system 1700. The system 1700 includes a processor 1710, a memory 1720, a storage device 1730, and an input/output device 1740. Each of the components 1710, 1720, 1730, and 1740 may be interconnected, for example, using a system bus 1750. The processor 1710 is capable of processing instructions for execution within the system 1700. In some implementations, the processor 1710 is a single-threaded processor. In some implementations, the processor 1710 is a multi-threaded processor. The processor 1710 is capable of processing instructions stored in the memory 1720 or on the storage device 1730.

The memory 1720 stores information within the system 1700. In some implementations, the memory 1720 is a non-transitory computer-readable medium. In some implementations, the memory 1720 is a volatile memory unit. In some implementations, the memory 1720 is a non-volatile memory unit.

The storage device 1730 is capable of providing mass storage for the system 1700. In some implementations, the storage device 1730 is a non-transitory computer-readable medium. In various different implementations, the storage device 1730 may include, for example, a hard disk device, an optical disk device, a solid-date drive, a flash drive, or some other large capacity storage device. For example, the storage device may store long-term data, such as data stored in the storage device 101 described with reference to FIGS. 1 and 2. The input/output device 1740 provides input/output operations for the system 1700. In some implementations, the input/output device 1740 may include one or more of a network interface devices, e.g., an Ethernet card, a serial communication device, e.g., an RS-232 port, and/or a wireless interface device, e.g., an 802.11 card, a 3G wireless modem, or a 4G wireless modem. A network interface device allows the system 1700 to communicate, for example, transmit and receive data such as non-binary files 221 and analysis results exchanged with the data analytics engine 115, or binary files sent to the connector module 105. In some implementations, the input/output device may include driver devices configured to receive input data and send output data to other input/output devices, e.g., keyboard, printer and display devices 1760. In some implementations, mobile computing devices, mobile communication devices, and other devices may be used.

In some implementations, at least a portion of the system 200 (FIG. 2) may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 101 may be implemented in a distributed way over a network, such as a server farm or a set of widely distributed servers, or may be implemented in a single computing device.

Although an example processing system has been described in FIG. 17, implementations of the subject matter and the functional operations described above may be implemented in other types of digital electronic circuitry, or in computer software, firmware, or hardware, including the structures disclosed in this specification and their structural equivalents, or in combinations of one or more of them. Implementations of the subject matter described in this specification may be implemented as one or more computer program products, i.e., one or more modules of computer program instructions encoded on a tangible program carrier, for example a non-transitory computer-readable medium, for execution by, or to control the operation of, a processing system. The non-transitory computer readable medium may be a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. A processing system may include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) may be written in any form of programming language, including compiled or interpreted languages, or declarative or procedural languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory may be supplemented by, or incorporated in, special purpose logic circuitry. Computers used in the system may be general purpose computers, custom-tailored special purpose electronic devices, or combinations of the two.

Implementations may include a back end component, e.g., a data server, or a middleware component, e.g., an application server, or a front end component, e.g., a client computer having a graphical user interface or a Web browser through which a user may interact with an implementation of the subject matter described is this specification, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

Certain features that are described above in the context of separate implementations may also be implemented in combination in a single implementation. Conversely, features that are described in the context of a single implementation may be implemented in multiple implementations separately or in any sub-combinations.

The order in which operations are performed as described above may be altered. In certain circumstances, multitasking and parallel processing may be advantageous. The separation of system components in the implementations described above should not be understood as requiring such separation.

Other implementations are within the scope of the following claims.

What is claimed is:

1. A computer-implemented method comprising:
accessing, by one or more processing devices, a file representing at least one spreadsheet;
analyzing the file by the one or more processing devices to identify a plurality of components of the spreadsheet, the plurality of components comprising at least two of: (i) a component representing content of the at least one spreadsheet, (ii) a component representing one or more formulae used within the at least one spreadsheet, (iii) a component representing one or more macros, (iv) a component representing one or more queries, and (v) a component representing links employed by the at least one spreadsheet;
creating, based on the components of the spreadsheet, a plurality of files that together represents the at least one spreadsheet, wherein each of the plurality of files correspond to a particular component of the identified plurality of components; and
storing the plurality of files at a storage location.

2. The method of claim 1, wherein the file representing the at least one spreadsheet is in a binary format.

3. The method of claim 1 wherein each of the plurality of files is in a format that can be processed by an analytics system configured to process large-scale datasets stored across a plurality of storage devices.

4. The method of claim 3, wherein a volume of the large-scale datasets is represented in one of: petabytes (10¹⁵ bytes), zettabytes (10²¹ bytes), yottabytes (10²⁴ bytes) or brontobytes (10²⁷ bytes).

5. The method of claim 3, wherein the analytics system comprises a Big Data analytics system.

6. The method of claim 1, wherein each of the plurality of files is in a non-binary format.

7. The method of claim 1 wherein the plurality of components further comprises a component representing event-driven programming language codes associated with the at least one spreadsheet.

8. The method of claim 7, wherein the event-driven programming language is Visual Basic for Applications (VBA).

9. The method of claim 6, wherein each of the plurality of files is a text file.

10. The method of claim 3, wherein the analytics system includes a framework for processing the large-scale dataset.

11. The method of claim 10, wherein the framework is Apache Hadoop framework.

12. The method of claim 11, wherein the storage location is a part of a distributed file system associated with the framework.

13. The method of claim 3, further comprising:
receiving from the analytics system, results based on an analysis of the plurality of files; and
displaying or storing the results on a display device or storage device, respectively.

14. A computer-implemented method comprising:
accessing, by one or more processing devices, a file representing at least one drawing;
analyzing the file by the one or more processing devices to identify a plurality of components of the drawing, the plurality of components comprising at least two of: (i) a component representing an object and coordinates associated with the object, (ii) a component representing one or more layers, (iii) a component representing one or more colors, (iv) a component representing one or more blocks, and (v) a component representing one or more external references;
creating, based on the components of the drawing, a plurality of files that together represents the drawing, wherein each of the plurality of files correspond to a particular component of the identified plurality of components; and
storing the plurality of files at a storage location.

15. The method of claim 14, wherein each of the plurality of files is in a format that can be processed by an analytics system configured to process large-scale dataset stored across a plurality of storage devices.

16. The method of claim 15, wherein the analytics system comprises a Big Data analytics system

17. The method of claim 14, wherein each of the plurality of files is in a non-binary format.

18. The method of claim 17, wherein each of the plurality of files is a text file.

19. The method of claim 15, wherein the analytics system includes a framework for processing the large-scale dataset.

20. The method of claim 19, wherein the framework is Apache Hadoop framework.

21. The method of claim 15, further comprising:
receiving from the analytics system, results based on an analysis of the plurality of files; and
displaying or storing the results on a display device or storage device, respectively, associated with the one or more processing devices.

22. A system comprising:
a storage device configured to store one or more files representing at least one spreadsheet; and
a computing device comprising a memory and processor, the computing device configured to:
access the one or more files stored in the storage device,
analyze the file to identify a plurality of components of the spreadsheet, the plurality of components comprising at least two of: (i) a component representing content of the at least one spreadsheet, (ii) a component representing one or more formulae used within the at least one spreadsheet, (iii) a component representing one or more macros, (iv) a component representing one or more queries, and (v) a component representing links employed by the at least one spreadsheet,
create a plurality of files that together represents the at least one spreadsheet, wherein each of the plurality of files correspond to a particular component of the identified plurality of components, and
store the plurality of files at a storage location.

23. The system of claim 22, wherein the file representing the at least one spreadsheet is in a binary format.

24. The system of claim 22 wherein each of the plurality of files is in a format that can be processed by an analytics system configured to process large-scale datasets stored across a plurality of storage devices.

25. A system comprising:
a storage device configured to store one or more files representing at least one drawing file; and
a computing device comprising a memory and processor, the computing device configured to:
access the one or more files stored in the storage device,
analyze the file to identify a plurality of components of the drawing, the plurality of components comprising at least two of: (i) a component representing an object and coordinates associated with the object, (ii) a component representing one or more layers, (iii) a component representing one or more colors, (iv) a component representing one or more blocks, and (v) a component representing one or more external references;
create, based on the components of the drawing, a plurality of files that together represents the drawing, wherein each of the plurality of files correspond to a particular component of the identified plurality of components; and
storing the plurality of files at a storage location.

26. The system of claim 25, wherein each of the plurality of files is in a format that can be processed by an analytics system configured to process large-scale dataset stored across a plurality of storage devices.

27. The system of claim 26, wherein each of the plurality of files is in a non-binary format.

28. The system of claim 27, wherein each of the plurality of files is a text file.

29. A computer-readable storage device storing instructions executable by one or more processing devices which, upon execution, cause the one or more processing devices to perform operations comprising:
accessing a file representing at least one spreadsheet;
analyzing the file to identify a plurality of components of the spreadsheet, the plurality of components comprising at least two of: (i) a component representing content of the at least one spreadsheet, (ii) a component representing one or more formulae used within the at least one spreadsheet, (iii) a component representing one or more macros, (iv) a component representing one or more queries, and (v) a component representing links employed by the at least one spreadsheet;
creating, based on the components of the spreadsheet, a plurality of files that together represents the at least one spreadsheet, wherein each of the plurality of files correspond to a particular component of the identified plurality of components; and
storing the plurality of files at a storage location.

30. A computer-readable storage device storing instructions executable by one or more processing devices which, upon execution, cause the one or more processing devices to perform operations comprising:
accessing a file representing at least one drawing;
analyzing the file to identify a plurality of components of the drawing, the plurality of components comprising at least two of: (i) a component representing an object and coordinates associated with the object, (ii) a component representing one or more layers, (iii) a component representing one or more colors, (iv) a component representing one or more blocks, and (v) a component representing one or more external references;
creating, based on the components of the drawing, a plurality of files that together represents the drawing, wherein each of the plurality of files correspond to a particular component of the identified plurality of components; and
storing the plurality of files at a storage location.
